(19) United States
(12) Patent Application Publication
(10) Pub. No.: US 2010/0235039 A1
(43) Pub. Date: Sep. 16, 2010

(54) WEIGHT AND GRADIENT ESTIMATION APPARATUS AND VEHICLE CONTROL APPARATUS USING THE SAME

(75) Inventors: Naoki Kajigai, Anjo-shi (JP); Noboru Fukuoka, Anjo-shi (JP); Osamu Sakamoto, Handa-shi (JP); Koji Harada, Kariya-shi (JP)

Correspondence Address: BUCHANAN, INGERSOLL & ROONEY PC, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 12/721,841

(22) Filed: Mar. 11, 2010

(30) Foreign Application Priority Data
Mar. 13, 2009 (JP) 2009-061294

(51) Int. Cl. G06F 7/00; G01S 19/13; B60W 10/06; B60W 10/18; B60W 10/10; B60W 30/18; B60W 40/06

(52) U.S. Cl. 701/29

(57) ABSTRACT

A weight and gradient estimation apparatus a height calculation portion calculating a height displacement of a road based on a first predetermined information obtained at a first time and a second predetermined information obtained at a second time after a predetermined time elapses since the first time, a gradient calculation portion calculating a road surface gradient based on the height displacement calculated by the height calculation portion and a moving distance of a vehicle from the first time to the second time, and a weight calculation portion calculating a weight of the vehicle based on the road surface gradient calculated by the gradient calculation portion, an acceleration of the vehicle, a speed of the vehicle, and an output torque of the vehicle.

### CROSS REFERENCE TO RELATED APPLICATIONS

This application is based on and claims priority under 35 U.S.C. §119 to Japanese Patent Application 2009-061294, filed on Mar. 13, 2009, the entire content of which is incorporated herein by reference.

### TECHNICAL FIELD

This disclosure relates to a weight and gradient estimation apparatus and a vehicle control apparatus using the same.

### BACKGROUND DISCUSSION

In order to improve a driving performance of a vehicle, the vehicle may be equipped with a vehicle control apparatus to estimate a vehicle weight and a road surface gradient and, on the basis of resulting estimated values, to control an automatic transmission, a brake, and the like. In the estimation of the vehicle weight and the road surface gradient, correctness and accuracy are desired and therefore various estimating methods are proposed.

For example, JP2004-45423A (hereinafter referred to as Reference 1) discloses a method in which when the road surface gradient is estimated by an acceleration sensor and at that time an output of the acceleration sensor suddenly changes (i.e., a transient state), a value obtained immediately before the sudden change of the output of the acceleration sensor is held as an estimated gradient value.

In addition, JP2006-322588A (hereinafter referred to as Reference 2) discloses a method in which a first estimated engine output torque is calculated on the basis of an intake air to an engine and an engine speed, and a second estimated engine output torque is calculated by correcting the calculated first estimated engine output torque based on a torque not transmitted to a transmission. Then, an estimated input shaft torque to a main shaft is calculated on the basis of the calculated second estimated engine output torque, and an estimated drive shaft torque to a drive shaft is calculated on the basis of the calculated estimated input shaft torque. Next, a drive force of a wheel is calculated on the basis of the calculated estimated drive shaft torque, and an estimated flat road driving acceleration that is an acceleration of the vehicle while the vehicle is being driven on the flat road is calculated on the basis of the calculated drive force. Meanwhile, an actual acceleration is calculated on the basis of a speed of the vehicle. Finally, a gradient of the road (i.e., the road surface) on which the vehicle is being driven is estimated from a difference between the estimated flat road driving acceleration and the actual acceleration of the vehicle.

Further, JP2001-108580A (hereinafter referred to as Reference 3) discloses a method in which a vehicle equipped with an atmospheric pressure sensor is driven on a road and changes of height (i.e., a height displacement) of the road is calculated on the basis of an atmospheric change for a short time period while the vehicle is being driven on the road. The gradient of the road relative to a driving distance of the vehicle is estimated on the basis of the height displacement per driving distance.

According to the method disclosed in Reference 1, however, information from the acceleration sensor is interfered by a disturbance caused by a vibration, an acceleration of the vehicle, and the like, which may lead to a limitation of a calculation timing of the gradient of the road surface. In addition, the method disclosed in Reference 1 has difficulties in being applied to a vehicle of which a weight greatly changes such as a truck and a towing vehicle. As a result, an accurate estimation of the gradient of the road surface may not be achieved. Further, according to the method disclosed in Reference 2, the gradient of the road surface is estimated on the basis of a difference between the estimated flat road driving acceleration and the actual acceleration. Thus, the method disclosed in Reference 2 has also difficulties in being applied to a vehicle of which a weight is greatly changed.

On the other hand, according to the method disclosed in Reference 3, the accurate gradient of the road surface is obtainable regardless of the vehicle weight and at a time of the sudden acceleration change. However, because the collection of gradient data for simulation is targeted according to the method disclosed in Reference 3, the gradient cannot be estimated in real time from obtained values of height. Thus, the estimated gradient value cannot be used for controlling the vehicle.

A need thus exists for a weight and gradient estimation apparatus and a vehicle control apparatus using the same which are not susceptible to the drawback mentioned above.

### SUMMARY

According to an aspect of this disclosure, a weight and gradient estimation apparatus includes a height calculation portion calculating a height displacement of a vehicle based on a first predetermined information obtained at a first time and a second predetermined information obtained at a second time after a predetermined time elapses since the first time, a gradient calculation portion calculating a road surface gradient based on the height displacement calculated by the height calculation portion and a moving distance of a vehicle from the first time to the second time, and a weight calculation portion calculating a weight of the vehicle based on the road surface gradient calculated by the gradient calculation portion, an acceleration of the vehicle, a speed of the vehicle, and an output torque of the vehicle.

According to another aspect of this disclosure, a vehicle control apparatus includes a weight and gradient estimation apparatus including a height calculation portion calculating a height displacement of a vehicle based on a first predetermined information obtained at a first time and a second predetermined information obtained at a second time after a predetermined time elapses since the first time, a gradient calculation portion calculating a road surface gradient based on the height displacement calculated by the height calculation portion and a moving distance of the vehicle from the first time to the second time, and a weight calculation portion calculating a weight of the vehicle based on the road surface gradient calculated by the gradient calculation portion, an acceleration of the vehicle, a speed of the vehicle, and an output torque of the vehicle, and a vehicle control portion controlling an operation of a controlled portion based on the road surface gradient calculated by the gradient calculation portion and the weight of the vehicle calculated by the weight calculation portion.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a block diagram schematically illustrating a structure of a vehicle control apparatus according to an embodiment disclosed here;

FIG. 2 is a schematic view illustrating a height and a gradient of a road estimated in the vehicle control apparatus according to the embodiment disclosed here;

FIG. 3 is a schematic view illustrating a dynamical state of a vehicle equipped with the vehicle control apparatus while the vehicle is being driven according to the embodiment disclosed here; and

FIG. 4 is a block diagram schematically illustrating another structure of the vehicle control apparatus according to the embodiment disclosed here.

### DETAILED DESCRIPTION

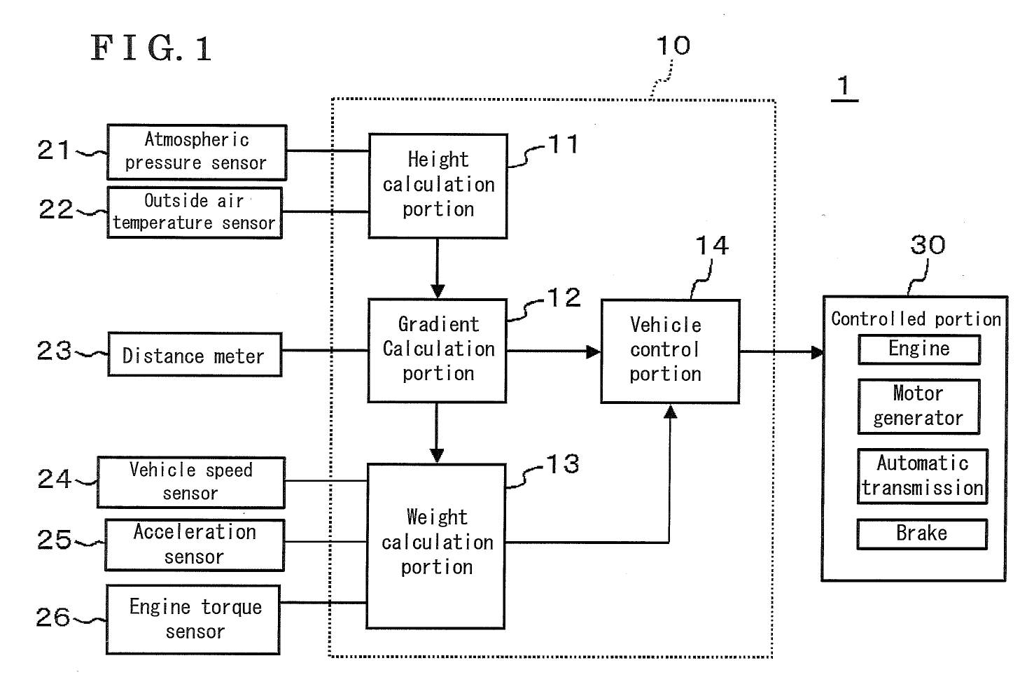

An embodiment disclosed here will be explained with reference to the attached drawings. A weight and gradient estimation apparatus according to the present embodiment includes a height calculation portion 11, a gradient calculation portion 12, and a weight calculation portion 13 as illustrated in FIG. 1. The height calculation portion 11 calculates a height displacement of a vehicle based on a first predetermined information obtained at a first time and a second predetermined information obtained at a second time after a predetermine time elapses since the first time. The gradient calculation portion 12 calculates a gradient of a road surface (i.e., a road surface gradient) based on the height displacement calculated by the height calculation portion 11 and a moving distance of the vehicle from the first time to the second time. The weight calculation portion 13 calculates a weight of the vehicle based on the road surface gradient calculated by the gradient calculation portion 12, an acceleration of the vehicle, a speed of the vehicle, and an output torque of the vehicle.

A vehicle control apparatus 1 according to the present embodiment shown in FIG. 1 includes the aforementioned weight and gradient estimation apparatus and a vehicle control portion 14 controlling an operation of a controlled portion 30 based on the road surface gradient calculated by the gradient calculation portion 12 and the vehicle weight calculated by the weight calculation portion 13.

Details of the vehicle control apparatus 1 according to the embodiment will be explained below. As illustrated in FIG. 1, the vehicle control apparatus 1 estimates the vehicle weight and the road surface gradient so as to control the controlled portion 30 such as an automatic transmission and a brake based on estimated values of the vehicle weight and the road surface gradient. The vehicle control apparatus 1 includes a computer unit 10 connected to the controlled portion 30 so that a communication therebetween is achievable and various sensors and measuring instruments 21 to 26 connected to the computer unit 10 so that a communication therebetween is achievable.

The computer unit 10 performs information processing based on a predetermined program including a database, a map, and the like. The computer unit 10 includes the height calculation portion 11, the gradient calculation portion 12, the weight calculation portion 13, and the vehicle control portion 14 all of which serve as main components that are achieved by an execution of the program.

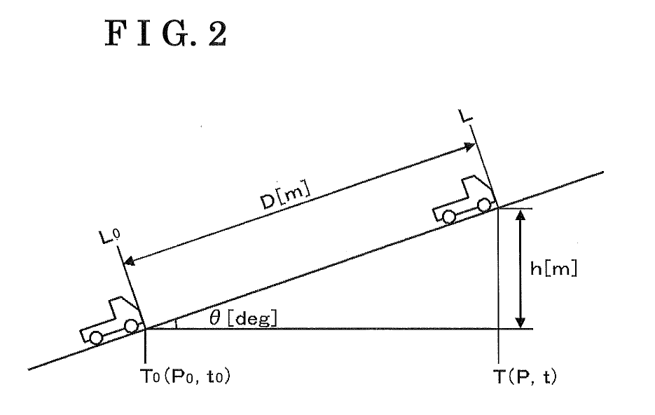

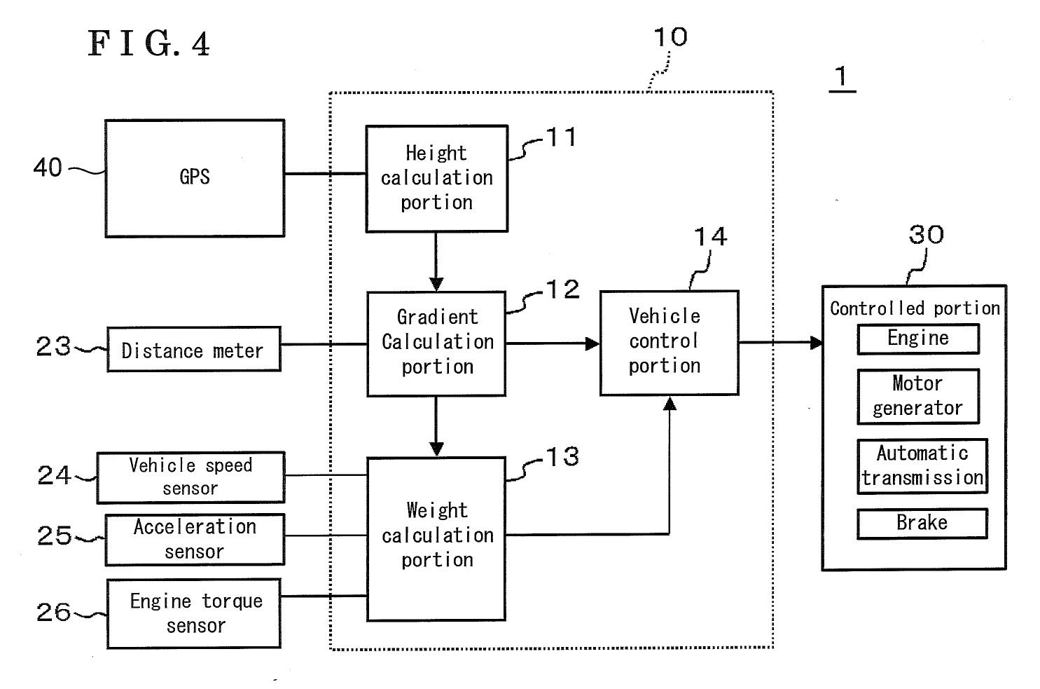

The height calculation portion 11 calculates the height displacement (m) of the road while the vehicle is being driven. Specifically, as illustrated in FIG. 2, the height calculation portion 11 calculates a height displacement h (m) based on a formula 1 shown below depending on an atmospheric pressure P₀ (Pa) serving as a first atmospheric pressure at a time T₀ serving as the first time, an atmospheric pressure P (Pa) serving as a second atmospheric pressure and an outside air temperature t (° C.) at a time T serving as the second time after a predetermined time elapses since the time T₀. The height calculation portion 11 obtains information related to the atmospheric pressure P₀ from an atmospheric pressure sensor 21 at the time T₀ and information related to the atmospheric pressure P from the atmospheric pressure sensor 21 in addition to information related to the outside air temperature t from an outside air temperature sensor 22 at the time T. The height calculation portion 11 outputs information related to the calculated height displacement h to the gradient calculation portion 12. According to the present embodiment, the height calculation portion 11 calculates the height displacement h based on the information from the atmospheric pressure sensor 21 and the outside air temperature sensor 22. Alternatively, in a case where the vehicle is equipped with a global positioning system (GPS, i.e., a positioning system) 40 as illustrated in FIG. 4, the height calculation portion 11 may obtain a first altitude at the time T₀ and a second altitude at the time T from the GPS to thereby calculate the height displacement (altitude difference). According to the GPS, the altitude of the present position of the vehicle (the road), for example, is obtainable by receiving a signal from a GPS satellite transmitter.

$$h = ( P - {P}_{0} ) \times \frac{13.6}{293} \times 1.205 \times \frac{{P}_{0}}{273 + t} 760 \qquad [ Formula 1 ]$$

The gradient calculation portion 12 calculates the road surface gradient (deg) while the vehicle is being driven. Specifically, the gradient calculation portion 12 calculates a road surface gradient θ based on a formula 2 shown below depending on the height displacement h (m), a moving distance D (m) of the vehicle from the time T₀ to the time T. The gradient calculation portion 12 obtains information related to a distance L₀ from a distance meter 23 at the time T₀ and information related to a distance L from the distance meter 23 at the time T in addition to information related to the height displacement h from the height calculation portion 11. The gradient calculation portion 12 obtains the moving distance D based on a difference between the obtained distance L₀ and the distance L. The gradient calculation portion 12 outputs the information related to the calculated road surface gradient θ to the weight calculation portion 13 and the vehicle control portion 14.

$$θ = {sin}^{- 1} \frac{h}{D} \qquad [ Formula 2 ]$$

The weight calculation portion 13 calculates the vehicle weight (kg). Specifically, the weight calculation portion 13 calculates a vehicle weight m (kg) based on a formula 3 shown below depending on an engine torque Tₑ (an output torque) (Nm) at the time T, a vehicle speed V (km/h) at the time T, an acceleration a (m/s²) at the time T, and the road surface gradient θ (deg). The weight calculation portion 13 obtains information related to the engine torque Tₑ from an engine torque sensor 26 (i.e., a torque sensor detecting an output torque of a power source output shaft) at the time T, information related to the vehicle speed V from a vehicle speed sensor 24 at the time T, and information related to the acceleration a from an acceleration sensor 25 at the time T in addition to information related to the road surface gradient θ from the gradient calculation portion 12. The weight calculation portion 13 outputs information related to the calculated vehicle weight m to the vehicle control portion 14. According to the present embodiment, the weight calculation portion 13 uses the information related to the acceleration a from the acceleration sensor 25. Alternatively, the weight calculation portion 13 may use an acceleration obtained by differentiating the vehicle speed V from the vehicle speed sensor 24, without the usage of the acceleration sensor 25. In addition, according to the present embodiment, the weight calculation portion 13 uses the information related to the engine torque Tₑ from the engine torque sensor 26. Alternatively, in a case where the vehicle is equipped with a torque sensor for a transmission output shaft, the weight calculation portion 13 may use an engine torque value obtained by dividing an output torque T_{OP} obtained from the torque sensor for the transmission output shaft by a gear ρ_{G}.

$$m = [ \frac{{T}_{e} \times {ρ}_{G} \times {ρ}_{D}}{r} + {μ}_{a} \times A \times {V}^{2} ] \times [ \frac{1}{a + ( {μ}_{r} + sin θ ) \times g} ] \qquad [ Formula 3 ]$$

In the above, “ρ_{G}” indicates a gear ratio, “ρ_{D}” indicates a final reduction gear ratio, “r” indicates a wheel external radius (m), “μₐ” indicates an air resistance coefficient, “A” indicates a frontal projected area (m²), “μᵣ” indicates a rolling resistance coefficient, and “g” indicates a gravitational acceleration (m/s²) all of which are constants.

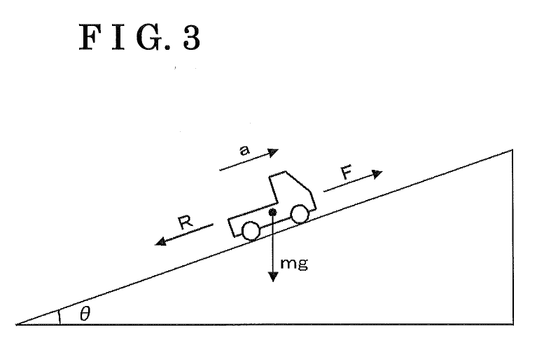

The aforementioned formula 3 is obtained by organizing the vehicle weight m based on equations of motion (formulas 4 to 6) indicating a dynamical state of the vehicle being driven (see FIG. 3) and formulas 7 to 10 related to a driving resistance R.

$$a = \frac{F - R}{m} \qquad [ Formula 4 ]$$

In the formula 4, “a” indicates the acceleration (m/s²), “F” indicates a driving force (N), “R” indicates the driving resistance (N), and “m” indicates the vehicle weight (kg).

$$F = \frac{{T}_{OP} \times {ρ}_{D}}{r} \qquad [ Formula 5 ]$$

In the formula 5, “F” indicates the driving force (N), “T_{OP}” indicates the output torque (Nm), “ρ_{D}” indicates the final reduction gear ratio, and “r” indicates the wheel external radius (m).

T_{OP}=Tₑ×ρ_{G} [Formula 6]

In the formula 6, “T_{OP}” indicates the output torque (Nm), “Tₑ” indicates the engine torque (Nm), and “ρ_{G}” indicates the gear ratio.

R=Rᵣ+Rₐᵢᵣ+Rₛ [Formula 7]

In the formula 7, “R” indicates the driving resistance (N), “Rᵣ” indicates a rolling resistance (N), “Rₐᵢᵣ” indicates an air resistance (N), and “Rₛ” indicates a hill-climbing resistance (N).

Rᵣ=μᵣ×m×g [Formula 8]

In the formula 8, “Rᵣ” indicates the rolling resistance (N), “μᵣ” indicates the rolling resistance coefficient, “m” indicates the vehicle weight (kg) and “g” indicates the gravitational acceleration (m/s²).

Rₐᵢᵣ=μₐ×A×V² [Formula 9]

In the formula 9, “Rₐᵢᵣ” indicates the air resistance (N), “A” indicates the frontal projected area (m²), and “V” indicates the vehicle speed (km/h).

Rₛ=m×g×sin θ [Formula 10]

In the formula 10, “Rₛ” indicates the hill-climbing resistance (N), “m” indicates the vehicle weight (kg), “g” indicates the gravitational acceleration, and “θ” indicates the road surface gradient (deg).

The vehicle control portion 14 controls an operation of the controlled portion 30 such as an engine, a motor generator, an automatic transmission, and a brake. The vehicle control portion 14 changes a control mode based on information related to the road surface gradient obtained from the gradient calculation portion 12 and the vehicle weight obtained from the vehicle weight calculation portion 13. The vehicle control portion 14 is provided within the computer unit 10 that includes the height calculation portion 11, the gradient calculation portion 12 and the weight calculation portion 13 in FIG. 1. Alternatively, only the vehicle control portion 14 may be provided in a different computer unit from the computer unit 10.

In a case of controlling the engine, for example, the vehicle control portion 14 selects and performs the control mode in which a fuel supply amount increases in association with an increase of the road surface gradient on an uphill and performs the control mode in which the fuel supply amount decreases in association with an increase of the road surface gradient on a downhill. The vehicle control portion 14 may perform the control mode in which the fuel supply amount increases in association with an increase of the vehicle weight. In a case of controlling the motor generator, for example, the vehicle control portion 14 selects and performs the control mode in which a power supply amount increases in association with the increase of the road surface gradient on the uphill and performs the control mode in which the power supply amount decreases or a regeneration of power is conducted in association with the increase of the road surface gradient on the downhill. The vehicle control portion 14 may perform the control mode in which the power supply amount increases in association with the increase of the vehicle weight. Further, in a case of controlling the automatic transmission, for example, the vehicle control portion 14 performs the control mode in which the lower gear range is used to a greater extent relative to the upper gear range in association with the increase of the road surface gradient on the uphill and performs the control mode in which the upper gear range is used to a greater extent relative to the lower gear range in association with the increase of the road surface gradient on the downhill. The vehicle control portion 14 may perform the control mode in which the lower gear range is used to a greater extent relative to the upper gear range in association with the increase of the vehicle weight. Furthermore, in a case of controlling the brake, the vehicle control portion 14 performs the control mode in which the braking force decreases in association with the increase of the road surface gradient on the uphill and performs the control mode in which the braking force increases in association with the decrease of the road surface gradient on the downhill. The vehicle control portion 14 may perform the control mode in which the braking force increases in association with the increase of the vehicle weight.

The atmospheric pressure sensor 21, which detects the atmospheric pressure, is mounted at a predetermined position of the vehicle and is connected to the computer unit 10 so that a communication therebetween is achievable.

The outside air temperature sensor 22, which detects the outside air temperature, is mounted at a predetermined position of the vehicle and is connected to the computer unit 10 so that a communication therebetween is achievable. At a time of the calculation of the height displacement, information from the outside air temperature sensor 22 may not be used. However, in a case where the information from the outside air temperature sensor 22 is used, the accuracy of the height displacement increases. At a time of the calculation of the height displacement, in a case where the information from the outside air temperature sensor 22 is not used, a temperature value fixed to a normal temperature such as 25° C. is used.

The distance meter 23, which detects the driving distance of the vehicle, is mounted on a predetermined position of the vehicle and is connected to the computer unit 10 so that a communication therebetween is achievable.

The vehicle speed sensor 24, which detects the vehicle speed, is mounted on a predetermined position of the vehicle and is connected to the computer unit 10 so that a communication therebetween is achievable.

The acceleration sensor 25, which detects the acceleration of the vehicle, is mounted at a predetermined position of the vehicle and is connected to the computer unit 10 so that a communication therebetween is achievable.

The engine torque sensor 26 serving as a torque sensor, which detects the engine torque, is mounted at a predetermined position of the vehicle and is connected to the computer unit 10 so that a communication therebetween is achievable.

The controlled portion 30 includes the engine, the motor generator, the automatic transmission, the brake, and the like controlled by the vehicle control portion 14. In the controlled portion 30, an actuator, and the like incorporated in the controlled portion 30 are operated in response to a control signal from the vehicle control portion 14.

According to the aforementioned embodiment, the accurate road surface gradient and the vehicle weight are obtainable in real time and at any time without being influenced by a shape of a vehicle (i.e., a passenger vehicle, a commercial vehicle, and a towing vehicle), an operation of the vehicle (i.e., accelerating and turning), a disturbance of the acceleration, and the like. In addition, the obtained gradient, the vehicle weight, and/or a combination thereof are used to control the controlled portion 30 such as the engine, the motor generator, the automatic transmission, and the brake to thereby achieve the appropriate driving performance. For example, in collaboration with a speed change control used for the brake control, the braking force when the vehicle is traveling downhill is optimized. The driving of the vehicle while the engine is conducting the fuel injection cutoff achieves an excellent driving performance and a fuel efficiency.

The weight and gradient estimation apparatus further includes the atmospheric pressure sensor 21 detecting an atmospheric pressure, wherein the height calculation portion 11 calculates the height displacement h based on the atmospheric pressure P₀ detected by the atmospheric pressure sensor 21 at the time T₀ and the atmospheric pressure P detected by the atmospheric pressure sensor 21 at the time T.

The weight and gradient estimation apparatus further includes the outside air temperature sensor 22 detecting an outside air temperature, wherein the height calculation portion 11 calculates the height displacement h based on the outside air temperature t detected by the outside air temperature sensor 22 at the time T.

The weight and gradient estimation apparatus further includes the positioning system (GPS) obtaining information related to an altitude of the vehicle by receiving a signal from a satellite transmitter, wherein the height calculation portion 11 calculates the height displacement h based on a difference between an altitude of the vehicle obtained by the positioning system at the time T₀ and an altitude of the vehicle obtained by the positioning system at the time T.

The weight and gradient estimation apparatus further includes the distance meter 23 measuring the moving distance D of the vehicle from the time T₀ to the time T, wherein the gradient calculation portion 12 calculates the road surface gradient θ based on the height displacement h calculated by the height calculation portion 11 and the moving distance D measured by the distance meter 23.

The weight and gradient estimation apparatus further includes the vehicle speed sensor 24 detecting the vehicle speed V, the acceleration sensor 25 detecting the acceleration a, and the engine torque sensor 26 detecting the engine torque Tₑ, wherein the weight calculation portion 13 calculates the vehicle weight m based on the road surface gradient θ calculated by the gradient calculation portion 12, the acceleration a detected by the acceleration sensor 25 at the time T, the vehicle speed V detected by the vehicle speed sensor 24 at the time T, and the engine torque Tₑ detected by the engine torque sensor 26 at the time T.

The weight and gradient estimation apparatus further includes the vehicle speed sensor 24 detecting the vehicle speed V and the engine torque sensor 26 detecting the engine torque Tₑ, wherein the weight calculation portion 13 calculates the vehicle weight m based on the acceleration calculated by differentiating the vehicle speed V detected by the vehicle speed sensor 24 at the time T, the road surface gradient θ calculated by the gradient calculation portion 12, the vehicle speed V detected by the vehicle speed sensor 24 at the time T, and the engine torque Tₑ detected by the engine torque sensor 26 at the time T.

The controlled portion 30 is at least one of an engine, a motor generator, an automatic transmission, and a brake controlled by the vehicle control portion 30.

The vehicle control portion 14 changes a control mode of the controlled portion 30 based on the road surface gradient calculated by the gradient calculation portion 12 and the vehicle weight calculated by the weight calculation portion 13.

The vehicle control portion 14 controls the engine by the control mode in which a fuel supply amount increases in association with an increase of the road surface gradient on an uphill and by the control mode in which the fuel supply amount decreases in association with the increase of the road surface gradient on a downhill.

The vehicle control portion 14 performs the control mode in which the fuel supply amount increases in association with an increase of the vehicle weight.

The vehicle control portion 14 controls the motor generator by the control mode in which a power supply amount increases in association with an increase of the road surface gradient on an uphill and by the control mode in which the power supply amount decreases in association with the increase of the road surface gradient on a downhill.

The vehicle control portion 14 controls the automatic transmission by the control mode in which a lower gear range is used to a greater extent relative to an upper gear range in association with an increase of the road surface gradient on an uphill and by the control mode in which the upper gear range is used to a greater extent relative to the lower gear range in association with the increase of the road surface gradient on a downhill.

The vehicle control portion 14 performs the control mode in which the lower gear range is used to a greater extent relative to the upper gear range in association with an increase of the weight of the vehicle.

The vehicle control portion 14 controls the brake by the control mode in which a braking force decreases in association with an increase of the road surface gradient on an uphill and by the control mode in which the braking force increases in association with the increase of the road surface gradient on a downhill.

The vehicle control portion 14 performs the control mode in which the braking force increases in association with an increase of the vehicle weight.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A weight and gradient estimation apparatus, comprising:
a height calculation portion calculating a height displacement of a vehicle based on a first predetermined information obtained at a first time and a second predetermined information obtained at a second time after a predetermined time elapses from the first time;
a gradient calculation portion calculating a road surface gradient based on the height displacement calculated by the height calculation portion and a moving distance of a vehicle from the first time to the second time; and
a weight calculation portion calculating a weight of the vehicle based on the road surface gradient calculated by the gradient calculation portion, an acceleration of the vehicle, a speed of the vehicle, and an output torque of the vehicle.

2. The weight and gradient estimation apparatus according to claim 1, further comprising an atmospheric pressure sensor detecting an atmospheric pressure, wherein the height calculation portion calculates the height displacement based on a first atmospheric pressure detected by the atmospheric pressure sensor at the first time and a second atmospheric pressure detected by the atmospheric pressure sensor at the second time.

3. The weight and gradient estimation apparatus according to claim 2, further comprising an outside air temperature sensor detecting an outside air temperature, wherein the height calculation portion calculates the height displacement based on the outside air temperature detected by the outside air temperature sensor at the second time.

4. The weight and gradient estimation apparatus according to claim 1, further comprising a positioning system obtaining an information related to an altitude of the vehicle by receiving a signal from a satellite transmitter, wherein the height calculation portion calculates the height displacement based on a difference between a first altitude of the vehicle obtained by the positioning system at the first time and a second altitude of the vehicle obtained by the positioning system at the second time.

5. The weight and gradient estimation apparatus according to claim 1, further comprising a distance meter measuring the moving distance of the vehicle from the first time to the second time, wherein the gradient calculation portion calculates the road surface gradient based on the height displacement calculated by the height calculation portion and the moving distance measured by the distance meter.

6. The weight and gradient estimation apparatus according to claim 1, further comprising:
a vehicle speed sensor detecting the speed of the vehicle;
an acceleration sensor detecting the acceleration of the vehicle; and
a torque sensor detecting the output torque of one of a power source output shaft and a transmission output shaft of the vehicle, wherein
the weight calculation portion calculates the weight of the vehicle based on the road surface gradient calculated by the gradient calculation portion, the acceleration of the vehicle detected by the acceleration sensor at the second time, the speed of the vehicle detected by the vehicle speed sensor at the second time, and the output torque of the vehicle detected by the torque sensor at the second time.

7. The weight and gradient estimation apparatus according to claim 1, further comprising:
a vehicle speed sensor detecting the speed of the vehicle; and
a torque sensor detecting the output torque of one of a power source output shaft and a transmission output shaft of the vehicle, wherein
the weight calculation portion calculates the weight of the vehicle based on the acceleration of the vehicle calculated by differentiating the speed of the vehicle detected by the vehicle speed sensor at the second time, the road surface gradient calculated by the gradient calculation portion, the speed of the vehicle detected by the vehicle speed sensor at the second time, and the output torque of the vehicle detected by the torque sensor at the second time.

8. A vehicle control apparatus comprising:
a weight and gradient estimation apparatus including a height calculation portion calculating a height displacement of a vehicle based on a first predetermined information obtained at a first time and a second predetermined information obtained at a second time after a predetermined time elapses since the first time, a gradient calculation portion calculating a road surface gradient based on the height displacement calculated by the height calculation portion and a moving distance of the vehicle from the first time to the second time, and a weight calculation portion calculating a weight of the vehicle based on the road surface gradient calculated by the gradient calculation portion, an acceleration of the vehicle, a speed of the vehicle, and an output torque of the vehicle; and
a vehicle control portion controlling an operation of a controlled portion based on the road surface gradient calculated by the gradient calculation portion and the weight of the vehicle calculated by the weight calculation portion.

9. The vehicle control apparatus according to claim 8, wherein the controlled portion is at least one of an engine, a motor generator, an automatic transmission, and a brake controlled by the vehicle control portion.

10. The vehicle control apparatus according to claim 9, wherein the vehicle control portion changes a control mode of the controlled portion based on the road surface gradient calculated by the gradient calculation portion and the weight of the vehicle calculated by the weight calculation portion.

11. The vehicle control apparatus according to claim 10, wherein the vehicle control portion controls the engine by the control mode in which a fuel supply amount increases in association with an increase of the road surface gradient on an uphill and by the control mode in which the fuel supply amount decreases in association with the increase of the road surface gradient on a downhill.

12. The vehicle control apparatus according to claim 11, wherein the vehicle control portion performs the control mode in which the fuel supply amount increases in association with an increase of the weight of the vehicle.

13. The vehicle control apparatus according to claim 10, wherein the vehicle control portion controls the motor generator by the control mode in which a power supply amount increases in association with an increase of the road surface gradient on an uphill and by the control mode in which the power supply amount decreases in association with the increase of the road surface gradient on a downhill.

14. The vehicle control apparatus according to claim 10, wherein the vehicle control portion controls the automatic transmission by the control mode in which a lower gear range is used to a greater extent relative to an upper gear range in association with an increase of the road surface gradient on an uphill and by the control mode in which the upper gear range is used to a greater extent relative to the lower gear range in association with the increase of the road surface gradient on a downhill.

15. The vehicle control apparatus according to claim 14, wherein the vehicle control portion performs the control mode in which the lower gear range is used to a greater extent relative to the upper gear range in association with an increase of the weight of the vehicle.

16. The vehicle control apparatus according to claim 10, wherein the vehicle control portion controls the brake by the control mode in which a braking force decreases in association with an increase of the road surface gradient on an uphill and by the control mode in which the braking force increases in association with the increase of the road surface gradient on a downhill.

17. The vehicle control apparatus according to claim 16, wherein the vehicle control portion performs the control mode in which the braking force increases in association with an increase of the weight of the vehicle.
